(19) United States
(12) Patent Application Publication
(10) Pub. No.: US 2022/0073768 A1
(43) Pub. Date: Mar. 10, 2022

(54) INKJET INK FOR TEXTILE PRINTING

(71) Applicant: Hewlett-Packard Development Company, L.P., Spring, TX (US)

(72) Inventors: Jie Zheng, San Diego, CA (US); Dennis Z. Guo, San Diego, CA (US)

(73) Assignee: Hewlett-Packard Development Company, L.P., Spring, TX (US)

(21) Appl. No.: 17/417,439

(22) PCT Filed: May 24, 2019
(86) PCT No.: PCT/US2019/033958

§ 371 Date: Jun. 23, 2021

(51) Int. Cl. C09D 11/322; C09D 11/102; C09D 11/037; C09D 11/033; C09D 11/54; D06P 5/30; D06P 1/52

(52) U.S. Cl. CPC C09D 11/322; C09D 11/102; C09D 11/037; D06P 1/5257; C09D 11/54; D06P 5/30; D06P 1/5285; C09D 11/033

(57) ABSTRACT

An example of an inkjet ink for textile printing includes a white pigment, a pigment dispersant, a non-crosslinked polyurethane-based binder, an additive, and a liquid vehicle. The pigment dispersant is selected from the group consisting of a water-soluble acrylic acid polymer, a branched co-polymer of a comb-type structure with polyether pendant chains and acidic anchor groups attached to a backbone, and a combination thereof. The additive is selected from the group consisting of a styrene maleic anhydride copolymer, a styrene maleic anhydride ester, and a combination thereof.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers are gaining acceptance for digital textile printing. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings.

FIG. 1 is a flow diagram illustrating an example of a printing method; and

FIG. 2 is a schematic diagram of an example of a printing system.

### DETAILED DESCRIPTION

The textile market is a major industry, and printing on textiles, such as cotton, etc., has been evolving to include digital printing methods. However, the vast majority of textile printing 95%) is still performed by analog methods, such as screen printing. Multi-color printing with analog screen printing involves the use of a separate screen for each color that is to be included in the print, and each color is applied separately (with its corresponding screen). In contrast, digital inkjet printing can generate many colors by mixing basic colors in desired locations on the textile, and thus avoids the limitations of analog screen printing.

Disclosed herein is an inkjet ink that is suitable for digital inkjet printing on a variety of textile fabrics, including cotton and cotton blends. The inkjet ink disclosed herein includes a white pigment, a pigment dispersant, a non-crosslinked polyurethane-based binder, an additive selected from the group consisting of a styrene maleic anhydride copolymer, a styrene maleic anhydride ester, and a combination thereof, and a liquid vehicle. The inkjet ink is water-based, and can be printed via thermal inkjet printers. It has been found that the additive improves the jettability (measured in terms of decap performance and Turn-On Energy (TOE) curves) of the inkjet ink, e.g., when compared to the jettability of inkjet inks including the same components as the inkjet ink disclosed herein except for the additive. More specifically, when the inkjet ink disclosed herein is thermal inkjet printed, the inkjet ink exhibits desirable decap performance and a desirable Turn-On Energy (TOE) curve.

The term “decap performance,” as referred to herein, means the ability of the inkjet ink to readily eject from the printhead, upon prolonged exposure to air. The decap time is measured as the amount of time that a printhead may be left uncapped (i.e., exposed to air) before the printer nozzles no longer fire properly, potentially because of clogging, plugging, or retraction of the colorant from the drop forming region of the nozzle/firing chamber. Good decap performance can lead to good jettability performance, and poor decap performance can lead to poor jettability performance. Further, when an ink has poor decap performance, repeated spitting may be performed to clear the printer nozzles, regain drop jettability, and improve print quality. Such repeated spitting may result in substantial ink waste, which may increase the printing cost. White ink is one of the most heavily used inks in textile printing. As such, a white inkjet ink for textile printing with good decap performance is desirable.

The term “Turn-On Energy (TOE) curve,” as used herein, refers to the drop weight of an inkjet ink as a function of firing energy. An inkjet ink with good jettability performance also has a good TOE curve, where the ink drop weight rapidly increases (with increased firing energy) to reach a designed drop weight for the pen architecture used; and then a steady drop weight is maintained when the firing energy exceeds the TOE. In other words, a sharp TOE curve may be correlated with good jettability performance. In contrast, an inkjet ink with a poor TOE curve may show a slow increase in drop weight (with increased firing energy) and/or may never reach the designed drop weight for the pen architecture. A poor TOE curve may be correlated with poor jettability performance.

Moreover, it has been found the additive disclosed herein improves the opacity (measured in terms of L*, i.e., lightness) of prints generated with the inkjet ink on pretreated black textile fabric. A greater L* value indicates a greater opacity of the white ink on the black fabric. L* is measured in the CIELAB color space, and may be measured using any suitable color measurement instrument (such as those available from HunterLab or X-Rite). The inkjet ink, when inkjet printed on a pretreated black textile fabric, may generate prints that have an L* value that is greater than prints generated on the same pretreated black textile fabric with comparative inkjet inks (e.g., those including the same components as the inkjet ink disclosed herein except for the additive).

The inkjet ink may include different components with different acid numbers. As used herein, the term “acid number” refers to the mass of potassium hydroxide (KOH) in milligrams that is used to neutralize one (1) gram of a particular substance. The test for determining the acid number of a particular substance may vary, depending on the substance. For example, to determine the acid number of a polyurethane-based binder, a known amount of a sample of the binder may be dispersed in water and the aqueous dispersion may be titrated with a polyelectrolyte titrant of a known concentration. In this example, a current detector for colloidal charge measurement may be used. An example of a current detector is the MUtek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC). It is to be understood that any suitable test for a particular component may be used.

Throughout this disclosure, a weight percentage that is referred to as “wt % active” refers to the loading of an active component of a dispersion or other formulation that is present in the inkjet ink or the pre-treatment composition. For example, the white pigment may be present in a water-based formulation (e.g., a stock solution or dispersion) before being incorporated into the inkjet ink. In this example, the wt % actives of the white pigment accounts for the loading (as a weight percent) of the white pigment that is present in the inkjet ink, and does not account for the weight of the other components (e.g., water, etc.) that are present in the formulation with the white pigment. The term “wt %,” without the term actives, refers to either i) the loading (in the inkjet ink or the pre-treatment composition) of a 100% active component that does not include other non-active components therein, or the loading (in the inkjet ink or the pre-treatment composition) of a material or component that is used “as is” and thus the wt % accounts for both active and non-active components.

Inkjet Inks

Examples of the inkjet ink disclosed herein will now be described. As mentioned above, the inkjet ink, when thermal inkjet printed, may exhibit a desirable decap performance and a desirable Turn-On Energy (TOE) curve. As also mentioned above, the inkjet ink, when inkjet printed on a pretreated black textile fabric, may generate prints that have a desirable L* value.

In some examples, the inkjet ink for textile printing comprises: a white pigment; a pigment dispersant selected from the group consisting of a water-soluble acrylic acid polymer, a branched co-polymer of a comb-type structure with polyether pendant chains and acidic anchor groups attached to a backbone, and a combination thereof; a non-crosslinked polyurethane-based binder; an additive selected from the group consisting of a styrene maleic anhydride copolymer, a styrene maleic anhydride ester, and a combination thereof; and a liquid vehicle. In some of these examples, the inkjet ink consists of these components with no other components. In these examples, the inkjet ink consists of the white pigment, the pigment dispersant, the polyurethane-based binder, the additive, and the liquid vehicle. In one of these examples, the liquid vehicle consists of water and a co-solvent. In other examples, the inkjet ink may include additional components.

Examples of the inkjet ink disclosed herein may be used in a thermal inkjet printer or in a piezoelectric printer to print on a (pre-treated) textile fabric. The viscosity of the inkjet ink may be adjusted for the type of printhead by adjusting the co-solvent level, adjusting the non-crosslinked polyurethane-based binder level, and/or adding a viscosity modifier. When used in a thermal inkjet printer, the viscosity of the inkjet ink may be modified to range from about 1 cP to about 9 cP (at 20° C. to 25° C.). When used in a piezoelectric printer, the viscosity of the inkjet ink may be modified to range from about 2 cP to about 20 cP (at 20° C. to 25° C.), depending on the type of the printhead that is being used (e.g., low viscosity printheads, medium viscosity printheads, or high viscosity printheads).

White Pigments

The white pigment may be incorporated into the inkjet ink as a white pigment dispersion. The white pigment dispersion may include a white pigment and a separate pigment dispersant.

For the white pigment dispersions disclosed herein, it is to be understood that the white pigment and separate pigment dispersant (prior to being incorporated into the ink formulation), may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the white pigment dispersion become part of the liquid vehicle in the inkjet ink.

Examples of suitable white pigments include white metal oxide pigments, such as titanium dioxide (TiO₂), zinc oxide (ZnO), zirconium dioxide (ZrO₂), or the like. In one example, the white pigment is titanium dioxide. In an example, the titanium dioxide is in its rutile form.

In some examples, the white pigment may include white metal oxide pigment particles coated with silicon dioxide (SiO₂). In one example, the white metal oxide pigment content to silicon dioxide content can be from 100:3.5 to 5:1 by weight. In other examples, the white pigment may include white metal oxide pigment particles coated with silicon dioxide (SiO₂) and aluminum oxide (Al₂O₃). In one example, the white metal oxide pigment content to total silicon dioxide and aluminum oxide content can be from 50:3 to 4:1 by weight. One example of the white pigment includes TI-PURE® R960 (TiO₂ pigment powder with 5.5 wt % silica and 3.3 wt % alumina (based on pigment content)) available from DuPont. Another example of the white pigment includes TI-PURE® R931 (TiO₂ pigment powder with 10.2 wt % silica and 6.4 wt % alumina (based on pigment content)) available from DuPont.

The white pigment may have high light scattering capabilities, and the average particle size of the white pigment may be selected to enhance light scattering and lower transmittance, thus increasing opacity. The average particle size of the white pigment may range anywhere from about 100 nm to about 2000 nm. In some examples, the average particle size ranges from about 120 nm to about 2000 nm, from about 150 nm to about 1000 nm, from about 150 nm to about 750 nm, or from about 200 nm to about 500 nm. The term “average particle size”, as used herein, may refer to a volume-weighted mean diameter of a particle distribution.

In an example, the white pigment is present in an amount ranging from about 3 wt % active to about 20 wt % active, based on a total weight of the inkjet ink. In other examples, the white pigment is present in an amount ranging from about 5 wt % active to about 20 wt % active, or from about 5 wt % active to about 15 wt % active, based on a total weight of the inkjet ink. In still another example, the white pigment is present in an amount of about 10 wt % active or about 9.75 wt % active, based on a total weight of the inkjet ink.

Pigment Dispersants

The white pigment may be dispersed with the pigment dispersant. In an example, the pigment dispersant is selected from the group consisting of a water-soluble acrylic acid polymer, a branched co-polymer of a comb-type structure with polyether pendant chains and acidic anchor groups attached to a backbone, and a combination thereof.

Some examples of the water-soluble acrylic acid polymer include CARBOSPERSE® K7028 (polyacrylic acid having a weight average molecular weight (Mw) of about 2,300), CARBOSPERSE® K752 (polyacrylic acid having a weight average molecular weight (Mw) of about 2,000), CARBOSPERSE® K7058 (polyacrylic acid having a weight average molecular weight (Mw) of about 7,300), and CARBOSPERSE® K732 (polyacrylic acid having a weight average molecular weight (Mw) of about 6,000), all available from Lubrizol Corporation.

Some examples of the branched co-polymer of the comb-type structure with polyether pendant chains and acidic anchor groups attached to the backbone include DISPERBYK®-190 (an acid number of about 10 mg KOH/g) and DISPERBYK®-199, both available from BYK Additives and Instruments, as well as DISPERSOGEN® PCE available from Clariant.

In some examples, the pigment dispersant is present in an amount ranging from about 0.05 wt % active to about 1 wt % active, based on a total weight of the inkjet ink. In one of these examples, the dispersant is present in an amount of about 0.23 wt % active, based on a total weight of the inkjet ink.

In some examples, the pigment dispersant includes both the water-soluble acrylic acid polymer and the branched co-polymer of the comb-type structure with polyether pendant chains and acidic anchor groups attached to the backbone. In some of these examples, the pigment dispersant includes CARBOSPERSE® K7028 and DISPERBYK®-190. In some of these examples, the pigment dispersant includes both the water-soluble acrylic acid polymer and the branched co-polymer of the comb-type structure with polyether pendant chains and acidic anchor groups attached to the backbone, where the water-soluble acrylic acid polymer is present in an amount ranging from about 0.02 wt % active to about 0.4 wt % active, and the branched co-polymer of the comb-type structure with polyether pendant chains and acidic anchor groups attached to the backbone is present in an amount ranging from about 0.03 wt % active to about 0.6 wt % active. In one of these examples, the water-soluble acrylic acid polymer is present in an amount of about 0.09 wt % active, and the branched co-polymer of the comb-type structure with polyether pendant chains and acidic anchor groups attached to the backbone is present in an amount of about 0.14 wt % active.

Non-Crosslinked Polyurethane-Based Binders

The inkjet ink also includes a non-crosslinked polyurethane-based binder. As used herein, “non-crosslinked” refers to a polymer that is not crosslinked with a crosslinker.

In some examples, the non-crosslinked polyurethane-based binder is selected from the group consisting of a polyester-polyurethane binder, a polyether-polyurethane binder, a polycarbonate-polyurethane binder, and combinations thereof.

In an example, the inkjet ink includes the polyester-polyurethane binder. In an example, the polyester-polyurethane binder is a sulfonated polyester-polyurethane binder. The sulfonated polyester-polyurethane binder can include diaminesulfonate groups. In an example, the non-crosslinked polyurethane-based binder is the polyester-polyurethane binder, the polyester-polyurethane binder is a sulfonated polyester-polyurethane binder, and is one of: i) an aliphatic compound including multiple saturated carbon chain portions ranging from C₄ to C₁₀ in length, and that is devoid of an aromatic moiety, or ii) an aromatic compound including an aromatic moiety and multiple saturated carbon chain portions ranging from C₄ to C₁₀ in length.

In one example, the sulfonated polyester-polyurethane binder can be anionic. In further detail, the sulfonated polyester-polyurethane binder can also be aliphatic, including saturated carbon chains as part of the polymer backbone or as a side-chain thereof, e.g., C₂ to C₁₀, C₃ to C₈, or C₃ to C₆ alkyl. These polyester-polyurethane binders can be described as “alkyl” or “aliphatic” because these carbon chains are saturated and because they are devoid of aromatic moieties. An example of an anionic aliphatic polyester-polyurethane binder that can be used is IMPRANIL® DLN-SD (CAS #375390-41-3; Mw 133,000; Acid Number 5.2; Tg −47° C.; Melting Point 175-200° C.) from Covestro. Example components used to prepare the IMPRANIL® DLN-SD or other similar anionic aliphatic polyester-polyurethane binders can include pentyl glycols (e.g., neopentyl glycol); C₄ to C₁₀ alkyldiol (e.g., hexane-1,6-diol); C₄ to C₁₀ alkyl dicarboxylic acids (e.g., adipic acid); C₄ to C₁₀ alkyl diisocyanates (e.g., hexamethylene diisocyanate (HDI)); diamine sulfonic acids (e.g., 2-[(2-aminoethyl)amino]ethanesulfonic acid); etc.

Alternatively, the sulfonated polyester-polyurethane binder can be aromatic (or include an aromatic moiety) and can include aliphatic chains. An example of an aromatic polyester-polyurethane binder that can be used is DISPERCOLL® U42 (CAS #157352-07-3). Example components used to prepare the DISPERCOLL® U42 or other similar aromatic polyester-polyurethane binders can include aromatic dicarboxylic acids, e.g., phthalic acid; C₄ to C₁₀ alkyl dialcohols (e.g., hexane-1,6-diol); C₄ to C₁₀ alkyl diisocyanates (e.g., hexamethylene diisocyanate (HDI)); diamine sulfonic acids (e.g., 2-[(2-aminoethyl)amino]ethanesulfonic acid); etc.

Other types of polyester-polyurethanes can also be used, including IMPRANIL® DL 1380, which can be somewhat more difficult to jet from thermal inkjet printheads compared to IMPRANIL® DLN-SD and DISPERCOLL® U42, but still can be acceptably jetted in some examples, and can also provide acceptable washfastness results on a variety of fabric types.

The polyester-polyurethane binders disclosed herein may have a weight average molecular weight (Mw, g/mol or Daltons) ranging from about 20,000 to about 300,000. In some examples of the inkjet ink, the non-crosslinked polyurethane-based binder is the polyester-polyurethane binder, and the polyester-polyurethane binder has a weight average molecular weight ranging from about 20,000 Mw to about 300,000 Mw. As examples, the weight average molecular weight can range from about 50,000 to about 500,000, from about 100,000 to about 400,000, or from about 150,000 to about 300,000.

The polyester-polyurethane binders disclosed herein may have an acid number that ranges from about 1 mg KOH/g to about 50 mg KOH/g. In some examples of the inkjet ink, the non-crosslinked polyurethane-based binder is the polyester-polyurethane binder, and the polyester-polyurethane binder has an acid number that ranges from about 1 mg KOH/g to about 50 mg KOH/g. As other examples, the acid number of the polyester-polyurethane binder can range from about 1 mg KOH/g to about 200 mg KOH/g, from about 2 mg KOH/g to about 100 mg KOH/g, or from about 3 mg KOH/g to about 50 mg KOH/g. For this binder, the term “acid number” refers to the mass of potassium hydroxide (KOH) in milligrams that is used to neutralize one gram of the polyester-polyurethane binder.

To determine this acid number, a known amount of a sample of the polyester-polyurethane binder may be dispersed in water and the aqueous dispersion may be titrated with a polyelectrolyte titrant of a known concentration. In this example, a current detector for colloidal charge measurement may be used. An example of a current detector is the MUtek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC).

The average particle size of the polyester-polyurethane binders disclosed herein may range from about 20 nm to about 500 nm. As examples, the sulfonated polyester-polyurethane binder can have an average particle size ranging from about 20 nm to about 500 nm, from about 50 nm to about 350 nm, or from about 100 nm to about 350 nm. The particle size of any solids herein, including the average particle size of the dispersed polymer binder, can be determined using a NANOTRAC® Wave device, from Microtrac, e.g., NANOTRAC® Wave II or NANOTRAC® 150, etc., which measures particles size using dynamic light scattering. Average particle size can be determined using particle size distribution data (e.g., volume weighted mean diameter) generated by the NANOTRAC® Wave device.

Other examples of the inkjet ink include a polyether-polyurethane binder. Examples of polyether-polyurethanes that may be used include IMPRANIL® LP DSB 1069, IMPRANIL® DLE, IMPRANIL® DAH, or IMPRANIL® DL 1116 (Covestro (Germany)); or HYDRAN® WLS-201 or HYDRAN® WLS-201K (DIC Corp. (Japan)); or TAKELAC® W-6061T or TAKELAC® WS-6021 (Mitsui (Japan)).

Still other examples of the inkjet ink include a polycarbonate-polyurethane binder. Examples of polycarbonate-polyurethanes that may be used as the non-crosslinked polyurethane-based binder include IMPRANIL® DLC-F or IMPRANIL® DL 2077 (Covestro (Germany)); or HYDRAN® WLS-213 (DIC Corp. (Japan)); or TAKELAC® W-6110 (Mitsui (Japan)).

In some examples of the inkjet ink, the non-crosslinked polyurethane-based binder is present in an amount ranging from about 2 wt % active to about 20 wt % active, based on a total weight of the inkjet ink. In another example, the non-crosslinked polyurethane-based binder can be present, in the inkjet ink, in an amount ranging from about 2 wt % active to about 15 wt % active based on the total weight of the inkjet ink. In still another example, the non-crosslinked polyurethane-based binder can be present, in the inkjet ink, in an amount of about 8 wt % active, based on the total weight of the inkjet ink.

The non-crosslinked polyurethane-based binder (prior to being incorporated into the inkjet ink) may be dispersed in water alone or in combination with an additional water soluble or water miscible co-solvent, such as those described for the white pigment dispersion. It is to be understood however, that the liquid components of the binder dispersion become part of the liquid vehicle in the inkjet ink.

Additives

The inkjet ink also includes the additive selected from the group consisting of a styrene maleic anhydride copolymer, a styrene maleic anhydride ester, and a combination thereof.

As mentioned above, the additive improves the jettability of the inkjet ink, where the jettability is measured in terms of decap performance and Turn-On Energy (TOE) curves). As also mentioned above, the additive improves the opacity (measured in terms of L*) of prints generated with the inkjet ink on pretreated black textile fabric.

In some examples, the additive includes the styrene maleic anhydride copolymer, and the styrene maleic anhydride copolymer has the formula:

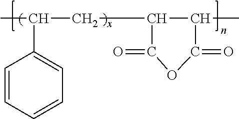

wherein: x is from 1 to 4, 6, or 8; and n is from 8 to 12.

In some of these examples, the styrene maleic anhydride copolymer may be formed from styrene monomers and maleic anhydride monomers according to the chemical equation:

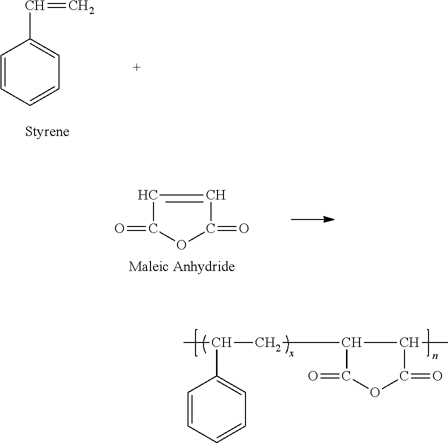

wherein: x is from 1 to 4, 6, or 8; and n is from 8 to 12.

One commercially available example of the styrene maleic anhydride copolymer includes SMA® 1000 (a low molecular weight styrene maleic anhydride copolymer with an approximately 1:1 styrene:maleic anhydride mole ratio and having a weight average molecular weight (Mw) of about 5,500, a number average molecular weight (Mn) of about 2,000, an acid number of about 480 mg KOH/g, and a T_{g} of about 155° C.) available from Cray Valley.

Other commercially available examples of the styrene maleic anhydride copolymer include SMA® 2000 (a low molecular weight styrene maleic anhydride copolymer with an approximately 2:1 styrene:maleic anhydride mole ratio and having a weight average molecular weight (Mw) of about 7,500, a number average molecular weight (Mn) of about 3,000, an acid number of about 355 mg KOH/g, and a T_{g} of about 135° C.), SMA® 2021 (a medium molecular weight styrene maleic anhydride copolymer with an approximately 2:1 styrene:maleic anhydride mole ratio and having a weight average molecular weight (Mw) of about 21,000, a number average molecular weight (Mn) of about 12,000, an acid number of about 355 mg KOH/g, and a T_{g} of about 155° C.), SMA® 3000 (a low molecular weight styrene maleic anhydride copolymer with an approximately 3:1 styrene:maleic anhydride mole ratio and having a weight average molecular weight (Mw) of about 9,500, a number average molecular weight (Mn) of about 3,800, an acid number of about 285 mg KOH/g, and a T_{g} of about 125° C.), and SMA® 3024 (a medium molecular weight styrene maleic anhydride copolymer with an approximately 3:1 styrene:maleic anhydride mole ratio and having a weight average molecular weight (Mw) of about 24,000, a number average molecular weight (Mn) of about 10,000, an acid number of about 285 mg KOH/g, and a T_{g} of about 141° C.) all available from Cray Valley.

In some examples, the additive includes the styrene maleic anhydride ester, and the styrene maleic anhydride ester has the formula:

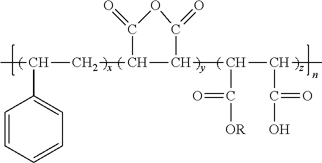

wherein: x is from 1 to 4; y is from 0.20 to 0.35; z is from 0.65 to 0.80; R is a carbon radical including from 1 to 24 carbon atoms; and n is from 8 to 12.

In some of these examples, the styrene maleic anhydride copolymer may be formed by the partial esterification of a styrene maleic anhydride copolymer (with an approximately 1:1 styrene:maleic anhydride mole ratio) according to the chemical equation:

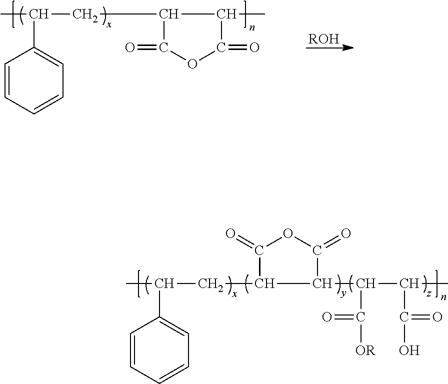

wherein: x is from 1 to 4; y is from 0.20 to 0.35; z is from 0.65 to 0.80; R is a carbon radical including from 1 to 24 carbon atoms; and n is from 8 to 12. In these examples, ROH may be any alcohol including from 1 to 24 carbon atoms. In some of these examples, ROH may be selected from the group consisting of isopropanol, phenol, and 2-butoxyethanol.

In other examples, the additive includes the styrene maleic anhydride ester, and the styrene maleic anhydride ester has the formula:

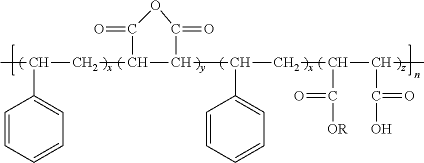

wherein: x is from 1 to 4; y is from 0.20 to 0.35; z is from 0.65 to 0.80; R is a carbon radical including from 1 to 24 carbon atoms; and n is from 8 to 12.

In some of these examples, the styrene maleic anhydride copolymer may be formed by the partial esterification of a styrene maleic anhydride copolymer (with an approximately 2:1 styrene:maleic anhydride mole ratio) according to the chemical equation:

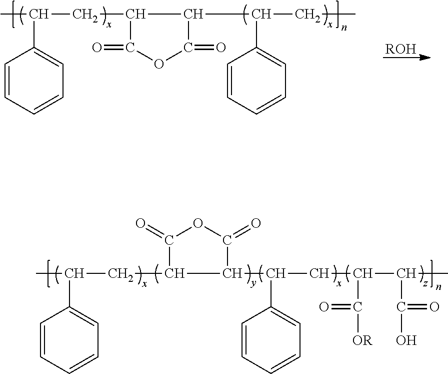

wherein: x is from 1 to 4; y is from 0.20 to 0.35; z is from 0.65 to 0.80; R is a carbon radical including from 1 to 24 carbon atoms; and n is from 8 to 12. In these examples, ROH may be any alcohol including from 1 to 24 carbon atoms. In some of these examples, ROH may be selected from the group consisting of isopropanol, phenol, and 2-butoxyethanol.

One commercially available example of the styrene maleic anhydride ester includes SMA® 17352 (a partial mono ester of styrene maleic anhydride having a weight average molecular weight (Mw) of about 7,000, a number average molecular weight (Mn) of about 2,800, an acid number of about 270 mg KOH/g, and a T_{g} of about 125° C.) available from Cray Valley. Another commercially available example of the styrene maleic anhydride ester includes SMA® 1440 (a partial mono ester of styrene maleic anhydride having a weight average molecular weight (Mw) of about 7,000, a number average molecular weight (Mn) of about 2,800, an acid number of about 185 mg KOH/g, and a T_{g} of about 60° C.) available from Cray Valley.

Still other commercially available examples of the styrene maleic anhydride ester include SMA® 2625 (a partial mono ester of styrene maleic anhydride having a weight average molecular weight (Mw) of about 9,000, a number average molecular weight (Mn) of about 3,600, an acid number of about 220 mg KOH/g, and a T_{g} of about 110° C.) and SMA® 3840 (a partial mono ester of styrene maleic anhydride having a weight average molecular weight (Mw) of about 10,500, a number average molecular weight (Mn) of about 4,200, an acid number of about 110 mg KOH/g, and a T_{g} of about 75° C.), both of which are available from Cray Valley.

In some examples, the additive is neutralized with a hydroxide (e.g., NaOH, KOH, etc.). In some of these examples, the additive includes sodium or potassium hydroxide, and is available as a salt. When the additive includes potassium hydroxide, the additive may be included in the inkjet ink as an aqueous potassium salt solution of the styrene maleic anhydride copolymer or the styrene maleic anhydride ester. When the additive includes sodium hydroxide, the additive may be included in the inkjet ink as an aqueous sodium salt solution of the styrene maleic anhydride copolymer or the styrene maleic anhydride ester.

In some examples, the additive is present in an amount ranging from about 0.1 wt % active to about 0.6 wt % active, based on a total weight of the inkjet ink. In some of these examples, the additive is present in an amount of about 0.1 wt % active, about 0.2 wt % active, about 0.3 wt % active, about 0.4 wt % active, or about 0.6 wt % active, based on the total weight of the inkjet ink.

Liquid Vehicles

In addition to the white pigment, the pigment dispersant, the non-crosslinked polyurethane-based binder, and the additive, the inkjet ink includes a liquid vehicle.

As used herein, the term “liquid vehicle” may refer to the liquid with which the white pigment (dispersion), the non-crosslinked polyurethane-based binder (dispersion), and the additive (solution) are mixed to form the inkjet ink. A wide variety of vehicles may be used with the inkjet ink of the present disclosure. The liquid vehicle may include water and any of: a co-solvent, an anti-decel agent, a surfactant, an antimicrobial agent, a pH adjuster, or combinations thereof. As such, in some examples, the inkjet ink further comprises a second additive selected from the group consisting of a non-ionic or an anionic surfactant, an antimicrobial agent, an anti-decel agent, and combinations thereof. In an example of the inkjet ink, the liquid vehicle includes water and a co-solvent. In another example, the liquid vehicle consists of water and the co-solvent. In still another example, the liquid vehicle consists of water and the co-solvent, the anti-decel agent, the surfactant, the antimicrobial agent, a pH adjuster, or a combination thereof. In still another example, the liquid vehicle consists of the anti-decel agent, the surfactant, the antimicrobial agent, a pH adjuster, and water.

The liquid vehicle may include co-solvent(s). The co-solvent(s) may be present in an amount ranging from about 4 wt % to about 30 wt % (based on the total weight of the inkjet ink). In an example, the total amount of co-solvent(s) present in the inkjet ink is about 10 wt % (based on the total weight of the inkjet ink).

In an example, the liquid vehicle includes glycerol. Other examples of co-solvents include aliphatic alcohols, aromatic alcohols, diols, glycol ethers, polyglycol ethers, lactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, 1,6-hexanediol or other diols (e.g., 1,5-pentanediol, 2-methyl-1,3-propanediol, etc.), ethylene glycol alkyl ethers, propylene glycol alkyl ethers, higher homologs (C₆-C₁₂) of polyethylene glycol alkyl ethers, triethylene glycol, tetraethylene glycol, tripropylene glycol methyl ether, N-alkyl caprolactams, unsubstituted caprolactams, 2-pyrrolidone, 1-methyl-2-pyrrolidone, N-(2-hydroxyethyl)-2-pyrrolidone, both substituted and unsubstituted formam ides, both substituted and unsubstituted acetamides, and the like. Other examples of organic co-solvents include dimethyl sulfoxide (DMSO), isopropyl alcohol, ethanol, pentanol, acetone, or the like.

The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2-hexanediol, 1,2,6-hexanetriol, glycerin, trimethylolpropane, and xylitol. Examples of polyhydric alcohol derivatives may include an ethylene oxide adduct of diglycerin.

The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

The liquid vehicle may include anti-decel agent(s). The anti-decel agent may function as a humectant. Decel refers to a decrease in drop velocity over time with continuous firing. In the examples disclosed herein, the anti-decel agent (s) is/are included to assist in preventing decel. In some examples, the anti-decel agent may improve the jettability of the inkjet ink. The anti-decel agent(s) may be present in an amount ranging from about 0.2 wt % active to about 5 wt % active (based on the total weight of the inkjet ink). In an example, the anti-decel agent is present in the inkjet ink in an amount of about 1 wt % active, based on the total weight of the inkjet ink.

An example of a suitable anti-decel agent is ethoxylated glycerin having the following formula:

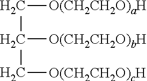

in which the total of a+b+c ranges from about 5 to about 60, or in other examples, from about 20 to about 30. An example of the ethoxylated glycerin is LIPON IC® EG-1 (LEG-1, glycereth-26, a+b+c=26, available from Lipo Chemicals).

The liquid vehicle of the inkjet ink may also include surfactant(s). In any of the examples disclosed herein, the surfactant may be present in an amount ranging from about 0.01 wt % active to about 5 wt % active (based on the total weight of the inkjet ink). In an example, the surfactant is present in the inkjet ink in an amount ranging from about 0.05 wt % active to about 3 wt % active, based on the total weight of the inkjet ink. In another example, the surfactant is present in the inkjet ink in an amount of about 0.3 wt % active, based on the total weight of the inkjet ink.

The surfactant may include anionic and/or non-ionic surfactants. Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsul fonate, and dibutylphenylphenol disulfonate. Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In some examples, the liquid vehicle may include a silicone-free alkoxylated alcohol surfactant such as, for example, TEGO® Wet 510 (Evonik Degussa) and/or a self-emulsifiable wetting agent based on acetylenic diol chemistry, such as, for example, SURFYNOL® SE-F (Evonik Degussa). Other suitable commercially available surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Evonik Degussa); ZONYL® FSO (a.k.a. CAPSTONE®, which is a water-soluble, ethoxylated non-ionic fluorosurfactant from DuPont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Company); and BYK® 345, BYK® 346, BYK® 347, BYK® 348, BYK® 349 (each of which is a silicone surfactant) (all of which are available from BYK Chemie).

The liquid vehicle may also include antimicrobial agent(s). Antimicrobial agents are also known as biocides and/or fungicides. In an example, the total amount of antimicrobial agent(s) in the inkjet ink ranges from about 0.01 wt % active to about 0.05 wt % active (based on the total weight of the inkjet ink). In another example, the total amount of antimicrobial agent(s) in the inkjet ink is about 0.04 wt % active (based on the total weight of the inkjet ink). In some instances, the antimicrobial agent may be present in the pigment dispersion that is mixed with the liquid vehicle.

Examples of suitable antimicrobial agents include the NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof.

The liquid vehicle may also include a pH adjuster. A pH adjuster may be included in the inkjet ink to achieve a desired pH (e.g., 8.5) and/or to counteract any slight pH drop that may occur over time. In an example, the total amount of pH adjuster(s) in the inkjet ink ranges from greater than 0 wt % to about 0.1 wt % (based on the total weight of the inkjet ink). In another example, the total amount of pH adjuster(s) in the inkjet ink is about 0.03 wt % (based on the total weight of the inkjet ink).

Examples of suitable pH adjusters include metal hydroxide bases, such as potassium hydroxide (KOH), sodium hydroxide (NaOH), etc. In an example, the metal hydroxide base may be added to the inkjet ink in an aqueous solution. In another example, the metal hydroxide base may be added to the inkjet ink in an aqueous solution including 5 wt % of the metal hydroxide base (e.g., a 5 wt % potassium hydroxide aqueous solution).

Suitable pH ranges for examples of the inkjet ink can be from pH 7 to pH 11, from pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, or from pH 7.5 to pH 8.

The balance of the inkjet ink is water. In an example, purified water or deionized water may be used. The water included in the inkjet ink may be: i) part of the white pigment dispersion, the binder dispersion, and/or the additive solution, ii) part of the liquid vehicle, iii) added to a mixture of the white pigment dispersion, the binder dispersion, and/or the additive solution and the liquid vehicle, or iv) a combination thereof. In some examples the inkjet ink is a thermal inkjet ink, and the liquid vehicle includes at least 70% by weight of water. In examples where the inkjet ink is a piezoelectric inkjet ink, the liquid vehicle is a solvent based vehicle including at least 50% by weight of the co-solvent.

Pre-Treatment Composition

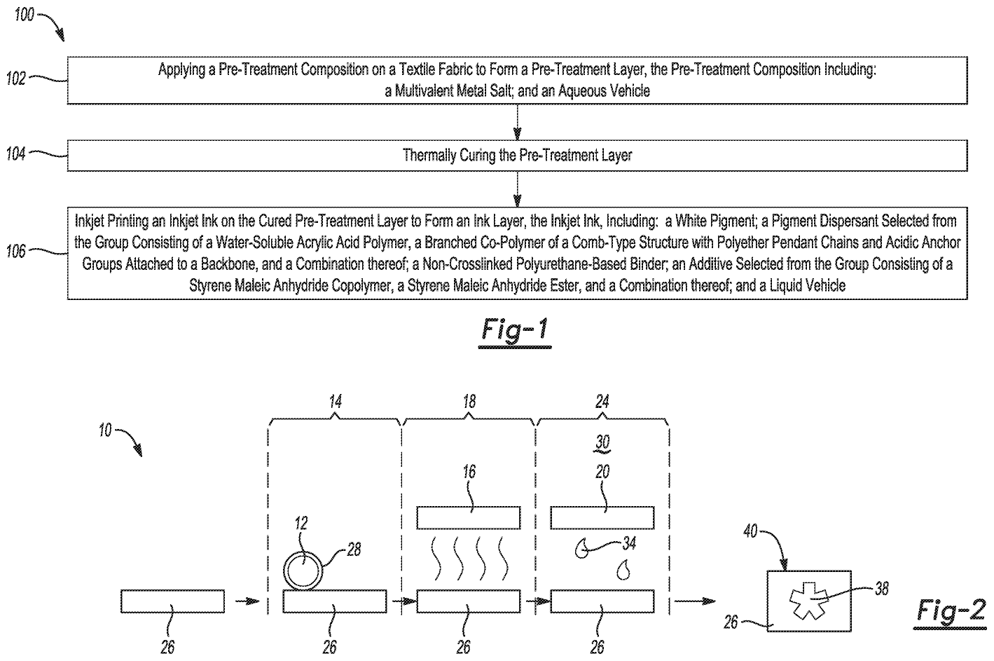

In an example of printing method (shown in FIG. 1) and for use in an example of a printing system (shown in FIG. 2), the pre-treatment composition includes a multivalent metal salt and an aqueous vehicle.

In some examples, the pre-treatment composition consists of the multivalent metal salt and the aqueous vehicle. In other examples, the pre-treatment composition may include additional components.

Some examples of the pre-treatment composition disclosed herein may be used in an analog applicator, such as an auto analog pretreater, a drawdown coater, a slot die coater, a roller coater, a fountain curtain coater, a blade coater, a rod coater, an air knife coater, a sprayer, or a gravure application to pre-treat a textile fabric. The viscosity of the pre-treatment composition may be adjusted for the type coater that is to be used. As an example, when the pre-treatment composition is to be applied with an analog applicator, the viscosity of the pre-treatment composition may range from about 100 centipoise (cP) to about 300 cP (at 20° C. to 25° C. and about 100 rotations per minute (rpm)).

An example of the pre-treatment composition that may be applied with an analog applicator includes Epson garment pretreatment liquid concentrate (a calcium-based pretreatment composition available from Seiko Epson Corporation). In another example, the Epson garment pretreatment liquid concentrate may be diluted with water, for example, at a weight ratio (of pretreatment liquid concentrate to water) of 1:2.

Other examples of the pre-treatment composition disclosed herein may be used in a thermal inkjet printer or in a piezoelectric printer to pre-treat a textile fabric. The viscosity of the pre-treatment composition may be adjusted for the type of printhead that is to be used, and the viscosity may be adjusted by adjusting the co-solvent level and/or adding a viscosity modifier. When used in a thermal inkjet printer, the viscosity of the pre-treatment composition may be modified to range from about 1 cP to about 9 cP (at 20° C. to 25° C.), and when used in a piezoelectric printer, the viscosity of the pre-treatment composition may be modified to range from about 2 cP to about 20 cP (at 20° C. to 25° C.), depending on the type of the printhead that is being used (e.g., low viscosity printheads, medium viscosity printheads, or high viscosity printheads).

Multivalent Metal Salts

The multivalent metal salt includes a multivalent metal cation and an anion. In an example, the multivalent metal salt includes a multivalent metal cation selected from the group consisting of a calcium cation, a magnesium cation, a zinc cation, an iron cation, an aluminum cation, and combinations thereof; and an anion selected from the group consisting of a chloride anion, an iodide anion, a bromide anion, a nitrate anion, a carboxylate anion, a sulfonate anion, a sulfate anion, and combinations thereof. In one specific example, the multivalent metal includes a calcium cation. In another example, the multivalent metal includes a calcium cation; and an anion selected from the group consisting of a chloride anion, an iodide anion, a bromide anion, a nitrate anion, a carboxylate anion, a sulfonate anion, a sulfate anion, and combinations thereof.

It is to be understood that the multivalent metal salt (containing the multivalent metal cation) may be present in any suitable amount. In an example, the metal salt is present in an amount ranging from about 2 wt % to about 20 wt % based on a total weight of the pre-treatment composition. In further examples, the metal salt is present in an amount ranging from about 4 wt % to about 12 wt %; or from about 5 wt % to about 15 wt %; or from about 6 wt % to about 10 wt %, based on a total weight of the pre-treatment composition.

Aqueous Vehicles

As mentioned above, the pre-treatment composition also includes an aqueous vehicle. As used herein, the term “aqueous vehicle” may refer to the liquid in which the multivalent metal salt is mixed to form the pre-treatment composition.

In an example of the pre-treatment composition, the aqueous vehicle includes a surfactant, a co-solvent, and a balance of water. In another example, the pre-treatment composition further comprises an additive selected from the group consisting of a chelating agent, an antimicrobial agent, an anti-kogation agent, a pH adjuster, and combinations thereof.

Some examples of the pre-treatment composition include a surfactant, a co-solvent, a chelating agent, and/or an antimicrobial agent. In these examples, the pre-treatment composition may include any of the examples of the surfactant, the co-solvent, the chelating agent, and/or the antimicrobial agent described above in reference to the liquid vehicle of the inkjet ink. In these examples, the pre-treatment composition may also include any of the surfactant, the co-solvent, the chelating agent, and/or the antimicrobial agent described above in reference to the liquid vehicle of the inkjet ink (with the amount(s) being based on the total weight of the pre-treatment composition rather than the total weight of the inkjet ink).

An anti-kogation agent may also be included in a pre-treatment composition that is to be thermal inkjet printed. Kogation refers to the deposit of dried printing liquid on a heating element of a thermal inkjet printhead. Anti-kogation agent(s) is/are included to assist in preventing the buildup of kogation. In some examples, the anti-kogation agent may improve the jettability of the pre-treatment composition. The anti-kogation agent(s) may be present in the pre-treatment composition in a total amount ranging from about 0.1 wt % active to about 1.5 wt % active, based on the total weight of the pre-treatment composition. In an example, the anti-kogation agent(s) is/are present in an amount of about 0.5 wt % active, based on the total weight of the pre-treatment composition.

Examples of suitable anti-kogation agents include oleth-3-phosphate (commercially available as CRODAFOS™ O3 A or CRODAFOS™ N-3A) or dextran 500 k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

A pH adjuster may also be included in the pre-treatment composition. A pH adjuster may be included in the pre-treatment composition to achieve a desired pH (e.g., 6) and/or to counteract any slight pH increase that may occur over time. In an example, the total amount of pH adjuster(s) in the pre-treatment composition ranges from greater than 0 wt % to about 0.1 wt % (based on the total weight of the pre-treatment composition). In another example, the total amount of pH adjuster(s) in the pre-treatment composition is about 0.03 wt % (based on the total weight of the pre-treatment composition).

An example of a suitable pH adjuster that may be used in the pre-treatment composition includes methane sulfonic acid.

Suitable pH ranges for examples of the pre-treatment composition can be from pH 4 to less than pH 9, from pH 5 to pH 8, or from pH 5.5 to pH 7. In one example, the pH of the pre-treatment composition is pH 6.

The balance of the pre-treatment composition is water. As such, the weight percentage of the water present in the pre-treatment composition will depend, in part, upon the weight percentages of the other components. The water may be purified water or deionized water.

Fluid Sets

The pre-treatment composition and the inkjet ink described herein may be part of a fluid set. In an example, the fluid set comprises: a pre-treatment composition, including: a multivalent metal salt; and an aqueous vehicle; and an inkjet ink, including: a white pigment; a pigment dispersant selected from the group consisting of a water-soluble acrylic acid polymer, a branched co-polymer of a comb-type structure with polyether pendant chains and acidic anchor groups attached to a backbone, and a combination thereof; a non-crosslinked polyurethane-based binder; an additive selected from the group consisting of a styrene maleic anhydride copolymer, a styrene maleic anhydride ester, and a combination thereof; and a liquid vehicle. The fluid set may also be include in a textile printing kit with any example of the textile fabric disclosed herein.

It is to be understood that any example of the inkjet ink may be used in the examples of the fluid set. It is also to be understood that any example of the pre-treatment composition may be used in the examples of the fluid set.

Textile Fabrics

In an example of printing method (shown in FIG. 1) and for use in an example of a printing system (shown in FIG. 2), the textile fabric is selected from the group consisting of cotton fabrics, cotton blend fabrics, nylon fabrics, nylon blend fabrics, silk fabrics, silk blend fabrics, wool fabrics, wool blend fabrics, and combinations thereof. In a further example, textile fabric is selected from the group consisting of cotton fabrics and cotton blend fabrics.

It is to be understood that organic textile fabrics and/or inorganic textile fabrics may be used for the textile fabric. Some types of fabrics that can be used include various fabrics of natural and/or synthetic fibers. In another example, the textile fabric may be selected from nylons (polyamides) or other synthetic fabrics.

Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the textile fabric/substrate can include polymeric fibers such as nylon fibers, polyvinyl chloride (PVC) fibers, polyamide, polyimide, polyacrylic, polypropylene, polyethylene, polyurethane, polystyrene, polyaramid (e.g., Kevlar®) polytetrafluoroethylene (Teflon®) (both trademarks of E.I. du Pont de Nemours and Company, Delaware), fiberglass, polytrimethylene, polycarbonate, polyethylene terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

It is to be understood that the terms “textile fabric” or “fabric substrate” do not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

Textile Printing Kit

The textile fabric, the pre-treatment composition, and the inkjet ink described herein may be part of a textile printing kit. In an example, the textile printing kit comprises: a textile fabric; a pre-treatment composition, including: a multivalent metal salt; and an aqueous vehicle; and an inkjet ink, including: a white pigment; a pigment dispersant selected from the group consisting of a water-soluble acrylic acid polymer, a branched co-polymer of a comb-type structure with polyether pendant chains and acidic anchor groups attached to a backbone, and a combination thereof; a non-crosslinked polyurethane-based binder; an additive selected from the group consisting of a styrene maleic anhydride copolymer, a styrene maleic anhydride ester, and a combination thereof; and a liquid vehicle. In another example, textile printing kit comprises: a textile fabric; and an inkjet ink, including: a white pigment; a pigment dispersant selected from the group consisting of a water-soluble acrylic acid polymer, a branched co-polymer of a comb-type structure with polyether pendant chains and acidic anchor groups attached to a backbone, and a combination thereof; a non-crosslinked polyurethane-based binder; an additive selected from the group consisting of a styrene maleic anhydride copolymer, a styrene maleic anhydride ester, and a combination thereof; and a liquid vehicle.

It is to be understood that any example of the inkjet ink may be used in the examples of the textile printing kit. It is also to be understood that any example of the pre-treatment composition may be used in the examples of the textile printing kit. Further, it is to be understood that any example of the textile fabric may be used in the examples of the textile printing kit. In one specific example of the textile printing kit, the textile fabric is selected from the group consisting of cotton fabrics, cotton blend fabrics, nylon fabrics, nylon blend fabrics, silk fabrics, silk blend fabrics, wool fabrics, wool blend fabrics, and combinations thereof.

Printing Method and System

FIG. 1 depicts an example of the printing method 100. As shown in FIG. 1, an example the printing method 100 comprises: applying a pre-treatment composition on a textile fabric to form a pre-treatment layer, the pre-treatment composition including: a multivalent metal salt; and an aqueous vehicle (as shown at reference numeral 102); thermally curing the pre-treatment layer (as shown at reference numeral 104); inkjet printing an inkjet ink on the cured pre-treatment layer to form an ink layer, the inkjet ink, including: a white pigment; a pigment dispersant selected from the group consisting of a water-soluble acrylic acid polymer, a branched co-polymer of a comb-type structure with polyether pendant chains and acidic anchor groups attached to a backbone, and a combination thereof; a non-crosslinked polyurethane-based binder; an additive selected from the group consisting of a styrene maleic anhydride copolymer, a styrene maleic anhydride ester, and a combination thereof; and a liquid vehicle layer (as shown at reference numeral 106).

It is to be understood that any example of the inkjet ink may be used in the examples of the method 100. It is also to be understood that any example of the pre-treatment composition may be used in the examples of the method 100. Further, it is to be understood that any example of the textile fabric may be used in the examples of the method 100.

As shown in reference numeral 102 in FIG. 1, the method 100 includes applying the pre-treatment composition on the textile fabric to form a pre-treatment layer.

In some examples of the method 100, the pre-treatment composition is applied at a coat weight ranging from about 100 grams per square meter (gsm) to about 400 gsm. In other examples, the pre-treatment composition is applied at a coat weight of about 250 gsm or about 243 gsm.

In some examples of the method 100, the pre-treatment composition may be applied using an auto analog pretreater, a drawdown coater, a slot die coater, a roller coater, a fountain curtain coater, a blade coater, a rod coater, an air knife coater, a sprayer, or a gravure application. In these examples, the pre-treatment composition may be coated on all or substantially all of the textile fabric. As such, the pre-treatment layer formed may be a continuous layer that covers all or substantially all of the textile fabric.

In other examples, the pre-treatment composition may be applied using inkjet printing. In these examples, the pre-treatment composition may be printed at desirable areas. As such, the pre-treatment layer that is formed by the application of the pre-treatment composition may be non-continuous. In other words, the pre-treatment layer may contain gaps where no pre-treatment composition is printed. When the pre-treatment composition is applied using inkjet printing, the pre-treatment composition may be applied in a manner similar to the inkjet printing of the inkjet ink.

As shown in reference numeral 104 in FIG. 1, after the pre-treatment composition is applied on the textile fabric to form the pre-treatment layer, the method 100 includes thermally curing the pre-treatment layer. The thermally curing of the pre-treatment layer may be accomplished by applying heat to the pre-treatment layer (or the textile fabric with the pre-treatment layer thereon). In an example of the method 100, the thermal curing involves heating the pre-treatment layer to a temperature ranging from about 80° C. to about 200° C., for a period of time ranging from about 10 seconds to about 15 minutes. In another example, the temperature ranges from about 100° C. to about 180° C. In still another example, thermal curing is achieved by heating the pre-treatment layer to a temperature of about 150° C. for about 30 seconds.

As shown in reference numeral 106 in FIG. 1, the method 100 includes inkjet printing the inkjet ink on the cured pre-treatment layer to form an ink layer. It is to be understood that the inkjet ink is printed at desirable areas. As such, the ink layer that is formed by the application of the inkjet ink may be non-continuous. In other words, the ink layer may contain gaps where no ink is printed.

In some examples of the method 100, the inkjet ink is printed to achieve greater than 250 grams per square meter (gsm) of the ink. In other examples, the inkjet ink is printed to achieve about 300 gsm of the ink.

The inkjet ink may be inkjet printed using any suitable inkjet applicator, such as a thermal inkjet printhead, a piezoelectric printhead, a continuous inkjet printhead, etc. The inkjet ink may be inkjet printed in a single pass or in multiple passes. As an example of single pass printing, the cartridge(s) of an inkjet printer deposit(s) the desired amount of the inkjet ink during the same pass of the cartridge(s) across the textile fabric. As an example of multiple pass printing, the cartridge(s) of an inkjet printer deposit the desired amount of the inkjet ink over several passes of the cartridge(s) across the textile fabric. In an example, the inkjet ink may be inkjet printed in 6 printing passes.

In some examples, the method 100 further comprises drying the ink layer. It is to be understood that in these examples, drying of the ink layer may be accomplished in any suitable manner, e.g., air dried, exposure to electromagnetic radiation (e.g. infra-red (IR) radiation), and/or the like.

Referring now to FIG. 2, a schematic diagram of a printing system 10 is shown. In this example, the printing system 10 includes a pre-treatment composition applicator 12 in a pre-treatment zone 14, a dryer 16 in a curing zone 18, and an inkjet printhead 20 in a printing zone 24.

In one example, a textile fabric/substrate 26 may be transported through the printing system 10 along the path shown by the arrows such that the textile fabric 26 is first fed to the pre-treatment zone 14. In the pre-treatment zone 14, an example of the pre-treatment composition 28 is applied directly onto the textile fabric 26 by the pre-treatment composition applicator 12 to form a pre-treatment layer on the textile fabric 26. While an analog applicator (e.g., an auto analog pretreater, a drawdown coater, a slot die coater, a roller coater, a fountain curtain coater, a blade coater, a rod coater, an air knife coater, a sprayer, or a gravure application) is shown as the pre-treatment composition applicator 12 in FIG. 2, it is to be understood that an inkjet printhead (for example, from a piezo- or thermal-inkjet printhead) may be used as the pre-treatment composition applicator 12 instead.

The textile fabric 26 (having the pre-treatment layer thereon) is then transported to the curing zone 18 where the pre-treatment layer is thermally cured. The heat is sufficient to evaporate all or substantially all of the liquid (e.g., water) from the pre-treatment layer. The heat to initiate curing may range from about 80° C. to about 200° C.

The textile fabric 26 (having the cured pre-treatment layer thereon) is then transported to the printing zone 24. In the printing zone 24 the textile fabric 26 is transported through an ink zone 30 where an example of the inkjet ink 34 is inkjet printed directly onto the cured pre-treatment layer by the inkjet printhead 20 (for example, from a piezo- or thermal-inkjet printhead) to form an ink layer on the cured pre-treatment layer. The ink layer may be heated in the printing zone 24 (for example, the air temperature in the printing zone 24 may range from about 10° C. to about 90° C.) such that the liquid (e.g., water) may be at least partially evaporated from the ink layer. The formation of the ink layer forms the printed article 40 including the image 38 formed on the textile fabric 26.

To further illustrate the present disclosure, examples are given herein. It is to be understood that these examples are provided for illustrative purposes and are not to be construed as limiting the scope of the present disclosure.

### EXAMPLES

### Example 1

Fifteen examples of the inkjet ink disclosed herein (ex. ink 1 through ex. ink 15) were prepared. Two comparative examples of the inkjet ink (comp. ink 1 and comp. ink 2) were also prepared. The example non-crosslinked polyurethane-based binder included in each of the inks was IMPRANIL® DLN-SD (CAS #375390-41-3; Mw 133,000; Acid Number 5.2; Tg −47° C.) from Covestro. The example white pigment dispersion included in each of the inks included an example white pigment and example pigment dispersants. The general formulation of the example white pigment dispersion included in each of the inks is shown in Table 1, with the wt % active of each component that was used.

TABLE 1

| Ingredient | Specific Component | wt % active |
|---|---|---|
| White pigment | TI-PURE ® R960 | 55 |
| Pigment | DISPERBYK ®-190 | 0.8 |
| dispersant | CARBOSPERSE ® K7028 | 0.5 |
| Water | Deionized water | Balance |

Each of the inks had the same formulation except for the type and amount of the additive used. The type and amount of the additive used in each of the inks is shown below in Table 3. The general formulation of the inks, except for type and amount of the additive, is shown in Table 2, with the wt % active of each component that was used (e.g., wt % active white pigment). A 5 wt % potassium hydroxide aqueous solution was added to each of the inks until a pH of about 8.5 was achieved.

TABLE 2

| | | Example and |
|---|---|---|
| | | comparative inks |
| Ingredient | Specific Component | (wt % active) |
| Pigment dispersion | White pigment dispersion | 10 |
| Binder | IMPRANIL ® DLN-SD | 8 |
| Co-solvent | Glycerol | 9 |
| | Tripropylene glycol | 2 |
| | methyl ether | |
| Anti-decel agent | LIPONIC ® EG-1 | 1 |
| Surfactant | SURFYNOL ® 440 | 0.3 |
| Antimicrobial agent | ACTICIDE ® B20 | 0.04 |
| Water | Deionized water | Balance |

Some of the example inks included SMA® 17352 (a partial mono ester of styrene maleic anhydride having a weight average molecular weight (Mw) of about 7,000, a number average molecular weight (Mn) of about 2,800, an acid number of about 270 mg KOH/g, and a T_{g} of about 125° C.) available from Cray Valley. The SMA® 17352 was the neutralized form, specifically a hydrolyzed potassium salt (i.e., an aqueous solution of the potassium salt of SMA® 17352).

Others of the example inks included SMA® 1000 (a low molecular weight styrene maleic anhydride copolymer with an approximately 1:1 mole ratio and having a weight average molecular weight (Mw) of about 5,500, a number average molecular weight (Mn) of about 2,000, an acid number of about 480 mg KOH/g, and a T_{g} of about 155° C.) available from Cray Valley. The SMA® 1000 was also the neutralized form, specifically a hydrolyzed sodium salt (i.e., an aqueous solution of the sodium salt of SMA® 1000).

Still others of the example inks included SMA® 1440 (a partial mono ester of styrene maleic anhydride having a weight average molecular weight (Mw) of about 7,000, a number average molecular weight (Mn) of about 2,800, an acid number of about 185 mg KOH/g, and a T_{g} of about 60° C.) available from Cray Valley. The SMA® 1440 was also the neutralized form, specifically a hydrolyzed potassium salt (i.e., an aqueous solution of the potassium salt of SMA® 1440).

Comp. ink 1 did not include the additive. Comp. ink 2 included ZETASPERSE® 3400 (an aqueous solution of anionic wetting dispersant polymers having the formula

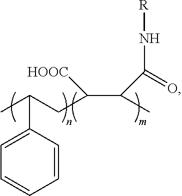

a weight average molecular weight (Mw) of about 4,900, and a number average molecular weight (Mn) of about 2,200) available from Evonik Degussa.

As mentioned above, the type and amount (wt % active) of the additive used in each of the inks is shown in Table 3.

TABLE 3

| | | Amount of |
|---|---|---|
| Example and | | additive used |
| comparative inks | Type of additive used | (wt % active) |
| Comp. ink 1 | None | 0.00 |
| Ex. ink 1 | SMA ® 17352 potassium salt | 0.60 |
| Ex. ink 2 | SMA ® 17352 potassium salt | 0.40 |
| Ex. ink 3 | SMA ® 17352 potassium salt | 0.30 |
| Ex. ink 4 | SMA ® 17352 potassium salt | 0.20 |
| Ex. ink 5 | SMA ® 17352 potassium salt | 0.10 |
| Ex. ink 6 | SMA ® 1000 sodium salt | 0.60 |
| Ex. ink 7 | SMA ® 1000 sodium salt | 0.40 |
| Ex. ink 8 | SMA ® 1000 sodium salt | 0.30 |
| Ex. ink 9 | SMA ® 1000 sodium salt | 0.20 |
| Ex. ink 10 | SMA ® 1000 sodium salt | 0.10 |
| Ex. ink 11 | SMA ® 1440 potassium salt | 0.60 |
| Ex. ink 12 | SMA ® 1440 potassium salt | 0.40 |
| Ex. ink 13 | SMA ® 1440 potassium salt | 0.30 |
| Ex. ink 14 | SMA ® 1440 potassium salt | 0.20 |
| Ex. ink 15 | SMA ® 1440 potassium salt | 0.10 |
| Comp. ink 2 | ZETASPERSE ® 3400 | 0.40 |

Decap Performance

The decap performance of each of the inks was tested. To test the decap performance, a reference line of the ink was printed from a printhead that was not uncapped (i.e., was not exposed to air). Then, the printhead was filled with the ink and left uncapped (i.e., exposed to air) for a predetermined amount of time (e.g., 0.07 seconds, 1.9 seconds, 3.99 seconds, or 7.91 seconds) before the ink was ejected again from the printhead. A score was then assigned to the ink based on the number of spits performed before a line with the same print quality as the reference line was printed. A lower decap score indicates higher quality firing of the nozzles and less clogging, plugging, or retraction of the colorant from the drop forming region of the nozzle/firing chamber. A decap score higher than 15 (>15) indicates that a good line was not obtained after 15 spits.

The results of the decap performance tests for each ink are shown in Table 4. The amount of time (i.e., 0.07 seconds, 1.9 seconds, 3.99 seconds, or 7.91 seconds) for which the printhead was left uncapped (i.e., exposed to air) is indicated in Table 4.

TABLE 4

| | Decap | Decap | Decap | Decap |
|---|---|---|---|---|
| Example and | performance | performance | performance | performance |
| comparative | after 0.07 | after 1.9 | after 3.99 | after 7.91 |
| inks | seconds | seconds | seconds | seconds |
| Comp. ink 1 | 1 | >15 | >15 | >15 |
| Ex. ink 1 | 1 | 2 | 3 | 5 |
| Ex. ink 2 | 1 | 2 | 4 | 11 |
| Ex. ink 3 | 1 | 2 | 5 | 12 |
| Ex. ink 4 | 1 | 3 | 5 | 12 |
| Ex. ink 5 | 1 | 3 | 6 | 14 |
| Ex. ink 6 | 1 | 2 | 4 | 6 |
| Ex. ink 7 | 1 | 2 | 4 | 8 |
| Ex. ink 8 | 1 | 3 | 5 | 11 |
| Ex. ink 9 | 1 | 2 | 3 | 11 |
| Ex. ink 10 | 1 | 2 | 3 | 11 |
| Ex. ink 11 | 1 | 2 | 3 | 4 |
| Ex. ink 12 | 1 | 2 | 3 | 6 |
| Ex. ink 13 | 1 | 2 | 3 | 6 |
| Ex. ink 14 | 1 | 2 | 8 | 14 |
| Ex. ink 15 | 1 | 2 | 4 | 10 |
| Comp. ink 2 | 1 | 2 | 12 | >15 |

As shown in Table 4, each of the example inks had better decap performance after longer times, including after 1.9 seconds, after 3.99 seconds, and after 7.91 seconds than comp. ink 1 (which did not include the additive). As also shown in Table 4, each of the example inks had better decap performance after 3.99 seconds and after 7.91 seconds than comp. ink 2 (which included ZETASPERSE® 3400 instead of the additive).

Turn-On Energy (TOE) Curves

A Turn-On Energy (TOE) curve was also created for each of the inks. The TOE curve for comp. ink 1 (which did not include the additive) was used as the reference curve. The TOE curves for the other inks were graded against the reference curve. A score was then assigned to the ink based on the amount of improvement or deterioration of its TOE curve relative to the reference curve.

A plus sign (+) indicates an improved TOE curve, and the number of plus signs indicate the degree of improvement. Improvement generally means that the ink drop weight rapidly increased more rapidly with increased firing energy, and thus reached the designed drop weight for the pen architecture quicker. In other words, one plus sign (+) indicates an improvement as compared to the reference curve; two plus signs (++) indicate a greater improvement than is indicated by one plus sign (+); and three plus sings (+++) indicate a greater improvement than is indicated by two plus signs (++). An equal sign (=) indicates no improvement or deterioration relative to the reference curve. An equal sign and a plus sign (=+) indicates a TOE curve that is partially similar to the reference curve and partially improved as compared to the reference curve. A minus sign (−) indicates a deteriorated TOE curve, and the number of minus signs indicate the degree of deterioration. In other words, one minus sign (−) indicates a deterioration as compared to the reference curve; two minus signs (−−) indicate a greater deterioration than is indicated by one minus sign (−); and three minus sings (−−−) indicate a greater deterioration than is indicated by two minus signs −−).

The TOE curve score of each of the inks is shown in Table 5.

TABLE 5

| Example and | |
|---|---|
| comparative inks | TOE curve |
| Comp. ink 1 | Reference |
| Ex. ink 1 | + + + |
| Ex. ink 2 | + + + |
| Ex. ink 3 | + + + |
| Ex. ink 4 | + + + |
| Ex. ink 5 | + + + |
| Ex. ink 6 | + |
| Ex. ink 7 | + |
| Ex. ink 8 | + + |
| Ex. ink 9 | + + + |
| Ex. ink 10 | + + + |
| Ex. ink 11 | + + |
| Ex. ink 12 | + + |
| Ex. ink 13 | = + |
| Ex. ink 14 | + + + |
| Ex. ink 15 | + + + |
| Comp. ink 2 | − − |

As shown in Table 5, each of the example inks had a better TOE curve than the reference curve of comp. ink 1 (which did not include the additive). As also shown in Table 5, some of the example inks had a much better TOE curve than the reference curve of comp. ink 1. Further, Table 5 shows that comp. ink 2 (which included ZETASPERSE® 3400 instead of the additive) had a worse TOE curve than the reference curve of comp. ink 1.

Opacity

The opacity of each of the inks was also tested. To test the opacity, prints were generated on black, 100% cotton fabric. To generate the prints, the black cotton fabric was pretreated with an example of the pretreatment composition disclosed herein. The example pretreatment composition was obtained by diluting Epson garment pretreatment liquid concentrate (Part Number C13T736100: a calcium-based pretreatment composition available from Seiko Epson Corporation) with water at a weight ratio (of pretreatment liquid concentrate to water) of 1:2. The example pretreatment composition was applied on the black cotton fabric with an auto analog pretreater at a coat weight of 243 grams per square meter (gsm). The pretreated fabric was cured at 150° C. for 30 seconds. Then, the ink was thermal inkjet printed on the cured, pretreated fabric to achieve about 300 gsm of the ink.

The L* value of each print was measured. L* is lightness, and a greater L* value indicates a greater opacity of the white ink on the black fabric.

The L* value of each print is shown in Table 6. In Table 6, each print is identified by the ink used to generate the print.

TABLE 6

| Example and | |
|---|---|
| comparative inks | L* Value |
| Comp. ink 1 | 63.4 |
| Ex. ink 1 | 80 |
| Ex. ink 2 | 80.5 |
| Ex. ink 3 | 76 |
| Ex. ink 4 | 71.2 |
| Ex. ink 5 | 58.8 |
| Ex. ink 6 | 72 |
| Ex. ink 7 | 68.5 |
| Ex. ink 8 | 65.9 |
| Ex. ink 9 | 65.6 |
| Ex. ink 10 | 60.7 |
| Ex. ink 11 | 80.3 |
| Ex. ink 12 | 74.8 |
| Ex. ink 13 | 72.7 |
| Ex. ink 14 | 69.5 |
| Ex. ink 15 | 57.7 |
| Comp. ink 2 | 60.3 |

As shown in Table 6, the prints generated using one of the example inks (Ex. ink 1-4, or Ex. ink 6-9, or Ex. ink 11-14) that included at least 0.2 wt % active of one of the example additives had better opacity than comp. ink 1 (which did not include the additive). As also shown in Table 6, comp. ink 2 (which included 0.4 wt % active of ZETASPERSE® 3400 instead of the additive) had worse opacity than comp. ink 1.

### Example 2

An additional comparative example of the inkjet ink (comp. ink 3) was prepared. This ink had the same ink formulation as described in Example 1 (Table 2), except that the additive was JONCRYL® 683 (a styrene acrylate having the formula

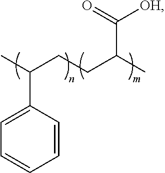

a weight average molecular weight of about 8,000, an acid number of about 165 mg KOH/g, and a T_{g} of about 75° C.) available from BASF Corp (Table 7) instead of the example additive disclosed herein.

Comp. ink 1 (from Example 1) was also used. The type and amount (wt % active) of the additive used in each of the inks is shown in Table 7.

TABLE 7

| | | Amount of |
|---|---|---|
| Example and | | additive used |
| comparative inks | Type of additive used | (wt % active) |
| Comp. ink 1 | None | 0.00 |
| Comp. ink 3 | JONCRYL ® 683 | 0.40 |

Decap Performance

The decap performance of each of these inks was tested. To test the decap performance, a printhead was filled with the ink and left uncapped (i.e., exposed to air) for a predetermined amount of time (e.g., 0.07 seconds, 1.9 seconds, 3.99 seconds, or 7.91 seconds) before the ink was ejected from the printhead.

Comp. ink 3 (which included JONCRYL® 683 instead of the additive) had worse decap performance after 1.9 seconds, after 3.99 seconds, and after 7.91 seconds than comp. ink 1 (which did not include the additive). As shown in Table 4 of Example 1, each of the example inks had better decap performance after longer times, including after 1.9 seconds, after 3.99 seconds, and after 7.91 seconds than comp. ink 1, and thus also performed better than comp. ink 3.

Turn-On Energy (TOE) Curves

A Turn-On Energy (TOE) curve was also created for each of the comparative inks (i.e., comp. ink 1 and comp. ink 3). The TOE curve for comp. ink 1 (which did not include the additive) was used as the reference curve. The TOE curve for comp. ink 3 was graded against the reference curve. Comp. ink 3 (which included JONCRYL® 683 instead of the additive) had a much worse TOE curve than the reference curve of comp. ink 1.

It is to be understood that the ranges provided herein include the stated range and any value or sub-range within the stated range, as if the value(s) or sub-range(s) within the stated range were explicitly recited. For example, a range from about 0.1 wt % active to about 0.6 wt % active, should be interpreted to include not only the explicitly recited limits of from about 0.1 wt % active to about 0.6 wt % active, but also to include individual values, such as about 0.15 wt % active, about 0.25 wt % active, about 0.40 wt % active, about 0.577 wt % active, etc., and sub-ranges, such as from about 0.133 wt % active to about 0.365 wt % active, from about 0.23 wt % active to about 0.47 wt % active, from about 0.35 wt % active to about 0.595 wt % active, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An inkjet ink for textile printing, the inkjet ink comprising:
a white pigment;
a pigment dispersant selected from the group consisting of a water-soluble acrylic acid polymer, a branched co-polymer of a comb-type structure with polyether pendant chains and acidic anchor groups attached to a backbone, and a combination thereof;
a non-crosslinked polyurethane-based binder;
an additive selected from the group consisting of a styrene maleic anhydride copolymer, a styrene maleic anhydride ester, and a combination thereof; and
a liquid vehicle.

2. The inkjet ink as defined in claim 1 wherein the additive includes the styrene maleic anhydride copolymer, and the styrene maleic anhydride copolymer has the formula: 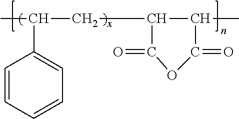
wherein:
x is from 1 to 4, 6, or 8; and
n is from 8 to 12.

3. The inkjet ink as defined in claim 1 wherein the additive includes the styrene maleic anhydride ester, and the styrene maleic anhydride ester has the formula: 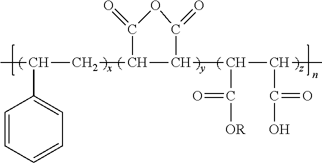
wherein:
x is from 1 to 4;
y is from 0.20 to 0.35;
z is from 0.65 to 0.80;
R is a carbon radical including from 1 to 24 carbon atoms; and
n is from 8 to 12.

4. The inkjet ink as defined in claim 1 wherein the additive includes the styrene maleic anhydride ester, and the styrene maleic anhydride ester has the formula: 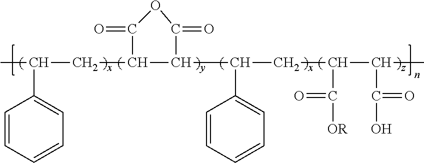
wherein:
x is from 1 to 4;
y is from 0.20 to 0.35;
z is from 0.65 to 0.80;
R is a carbon radical including from 1 to 24 carbon atoms; and
n is from 8 to 12.

5. The inkjet ink as defined in claim 1 wherein the additive is neutralized with a hydroxide.

6. The inkjet ink as defined in claim 1 wherein the additive is present in an amount ranging from about 0.1 wt % active to about 0.6 wt % active, based on a total weight of the inkjet ink.

7. The inkjet ink as defined in claim 1 wherein the non-crosslinked polyurethane-based binder is selected from the group consisting of a polyester-polyurethane binder, a polyether-polyurethane binder, a polycarbonate-polyurethane binder, and combinations thereof.

8. The inkjet ink as defined in claim 1 wherein the non-crosslinked polyurethane-based binder is present in an amount ranging from about 2 wt % active to about 20 wt % active, based on a total weight of the inkjet ink.

9. The inkjet ink as defined in claim 1 wherein the inkjet ink consists of the white pigment, the pigment dispersant, the polyurethane-based binder, the additive, and the liquid vehicle.

10. The inkjet ink as defined in claim 9 wherein the liquid vehicle consists of water and a co-solvent.

11. The inkjet ink as defined in claim 1 wherein the white pigment is present in an amount ranging from about 3 wt % active to about 20 wt % active, based on a total weight of the inkjet ink.

12. The inkjet ink as defined in claim 1 wherein the pigment dispersant is present in an amount ranging from about 0.05 wt % active to about 1 wt % active, based on a total weight of the inkjet ink.

13. A fluid set, comprising:
a pre-treatment composition, including:
a multivalent metal salt; and
an aqueous vehicle; and
an inkjet ink, including:
a white pigment;
a pigment dispersant selected from the group consisting of a water-soluble acrylic acid polymer, a branched co-polymer of a comb-type structure with polyether pendant chains and acidic anchor groups attached to a backbone, and a combination thereof;
a non-crosslinked polyurethane-based binder;
an additive selected from the group consisting of a styrene maleic anhydride copolymer, a styrene maleic anhydride ester, and a combination thereof; and
a liquid vehicle.

14. A textile printing kit, comprising:
a textile fabric;
a pre-treatment composition, including:
a multivalent metal salt; and
an aqueous vehicle; and
an inkjet ink, including:
a white pigment;
a pigment dispersant selected from the group consisting of a water-soluble acrylic acid polymer, a branched co-polymer of a comb-type structure with polyether pendant chains and acidic anchor groups attached to a backbone, and a combination thereof;
a non-crosslinked polyurethane-based binder;
an additive selected from the group consisting of a styrene maleic anhydride copolymer, a styrene maleic anhydride ester, and a combination thereof; and
a liquid vehicle.

15. The textile printing kit as defined in claim 14 wherein the textile fabric is selected from the group consisting of cotton fabrics, cotton blend fabrics, nylon fabrics, nylon blend fabrics, silk fabrics, silk blend fabrics, wool fabrics, wool blend fabrics, and combinations thereof.
